(19) United States
(12) Patent Application Publication
(10) Pub. No.: US 2006/0005148 A1
(43) Pub. Date: Jan. 5, 2006

(54) System and method for content-based filtering of popup objects

(75) Inventors: David J. Cheng, Redmond, WA (US); Sean E. Purcell, Seattle, WA (US); Eyal Schwartz, Bellevue, WA (US)

Correspondence Address: SHOOK, HARDY & BACON L.L.P.;(c/o MICROSOFT CORPORTATION), 2555 GRAND BOULEVARD, KANSAS CITY, MO, 64108-2613, US

(73) Assignee: Microsoft Corporation, Redmond, WA (US)

(21) Appl. No.: 10/879,049

(22) Filed: Jun. 30, 2004

(51) Int. Cl. G06F 17/00

(52) U.S. Cl. 715/808

(57) ABSTRACT

A system and related techniques automatically monitor browser and other sessions to detect the onset of a popup or other automatically generated windows or media. When a popup object is detected, a filter or engine may examine the content of that object to generate an estimate of the desirability of the popup to the user. The content-based evaluation of the popup may examine, for instance, the source of the popup, the type or quantity of embedded image files, text including keywords, embedded links and a variety of other factors to assess the likelihood that the popup was related to the user's legitimate browser activity or otherwise likely to be desired by the user. If not, the platform may suppress the popup or other object without user intervention. In embodiments, the content analysis may be performed by a self-learning network such as a neural network, for instance based on stored feedback from a collection of users, or otherwise.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The invention relates to the field of computer interfaces, and more particularly to advanced techniques for analyzing and filtering popups generated from browser or other activity, based on the content of those popups.

### BACKGROUND OF THE INVENTION

The advertising exposure of the numerous people who browse the Internet every day has led to a proliferation of automatic advertising mechanisms in the Web space. One mechanism for presenting automatic advertising is the browser popup. The popup is typically a reduced-size, second window or frame which is automatically spawned when a user visits a certain Web site, or when associated client-side activities, such as a mouse click or other triggers occur.

Popups may at times represent a distraction to some users, especially when those users are forced to click them away to cancel undesired ads or information. As a result some commercial and freeware popup blockers or stoppers have been developed. In general these tools trap new popups at the incipient stage before they are displayed, for example by detecting a new window event in the browser or other application.

However, once detected, existing popup stopper tools typically base their decision to allow or suppress a given popup on limited decision logic. For example, many popup stopper tools allow the user to create a list of popups they always wish to allow (whitelist), such as popups from their bank or other financial institutions. Conversely the user may create a list of popups they always wish to block (blacklist), such as popups related to undesired products or services. When a popup is initiated that is neither prohibited nor allowed, such tools may query the user through a dialog box to allow the popup, or to put the source into the whitelist or blacklist. Another known technique is to block all popups except those which were spawned by a user-initiated action, such as activation of a link or mouse click.

These types of decisioning are in general however rigid, categorical and therefore limited in effectiveness. Existing tools for instance make no attempt to predict the desirability of the popup to the user without a priori knowledge or feedback from that user. Instead they merely apply a yes/no decisioning approach. As a result existing popup tools may block some popups which the user might have found useful, or allow some popups which the user may have no interest in. Other problems in popup management technology exist.

### SUMMARY OF THE INVENTION

The invention overcoming these and other problems in the art relates in one regard to a system and method for content-based filtering of popup and other automated display objects, in which a newly initiated popup is trapped before it is presented. The popup object may then be automatically analyzed for suppression or display based on its content. In embodiments, the popup may be kept in a hidden or non-displayed state while it is subjected to heuristics, filtering and other processing which detects and examines the actual content of the popup to predict the object's desirability for display. The decisioning logic may assess a variety of variables, such as popup source, the presence or absence of images, keywords and other factors to generate a rating on the popup object. The rating may reflect a measure of confidence that the subject popup may represent a desired piece of information, such as a query box on a banking form activated by a user. When the rating surpasses a threshold for desirable content, according to embodiments of the invention the decisioning logic may present the popup for display. When the rating does not reach the threshold, the popup may be suspended or terminated. The decisioning logic which analyzes the content-based and other factors may in embodiments be or include a self-learning network such as a support vector machine or a neural network, or other logic. In embodiments the user may selectively choose or input thresholds or criteria upon which the content-based decisioning may be made.

### BRIEF DESCRIPTION OF THE DRAWINGS

FIG. 1 illustrates a networked environment in which content-based filtering of popups may operate, according to embodiments of the invention.

FIG. 2 illustrates a parent window from which popup objects may be generated, according to embodiments of the invention.

FIG. 3 illustrates a user control interface for popup filter settings, according to embodiments of the invention.

FIG. 4 illustrates a flowchart of overall content-based popup filter processing, according to embodiments of the invention.

### DETAILED DESCRIPTION OF EMBODIMENTS

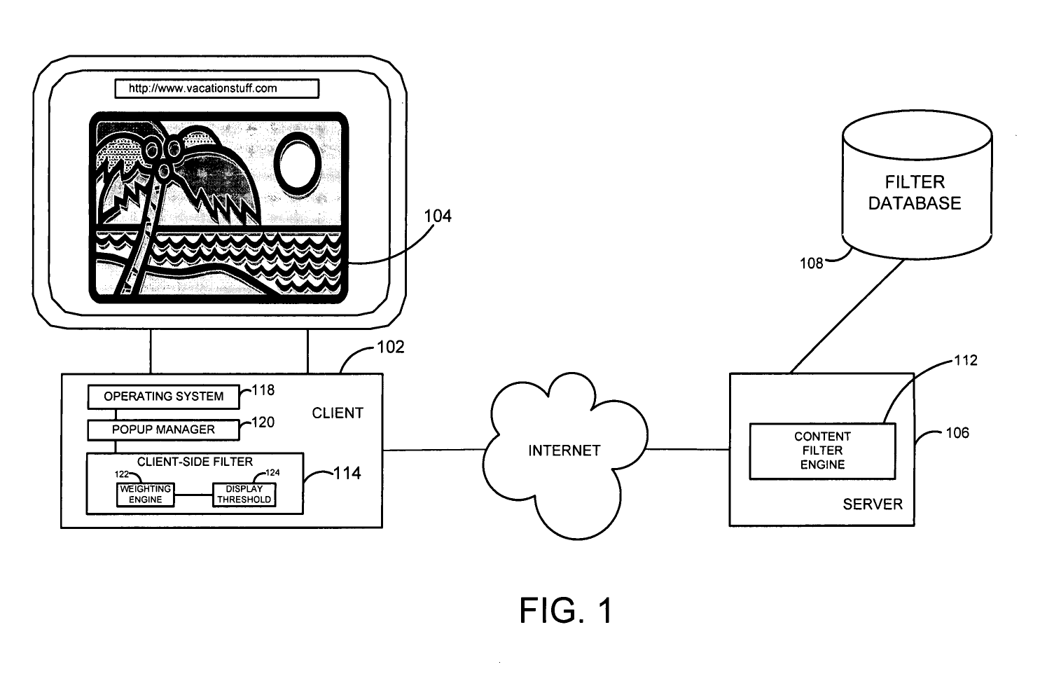

FIG. 1 illustrates an environment in which a system and method for content-based filtering of popup objects may operate, according to embodiments of the invention. As illustrated in that figure, according to embodiments a user may operate a client 102, such as a personal computer, to view Internet or other sites or content. That content may be displayed in parent window 104, which may for example be or include a browser window presented in a graphical user interface. The client may contain system resources including an operating system 118, such as the Microsoft Windows™ family of operating systems, or others. The client 102 may likewise host a popup manager 120 communicating with a client-side filter 114 to support popup detection and decisioning logic, based in one regard on the content of those objects.

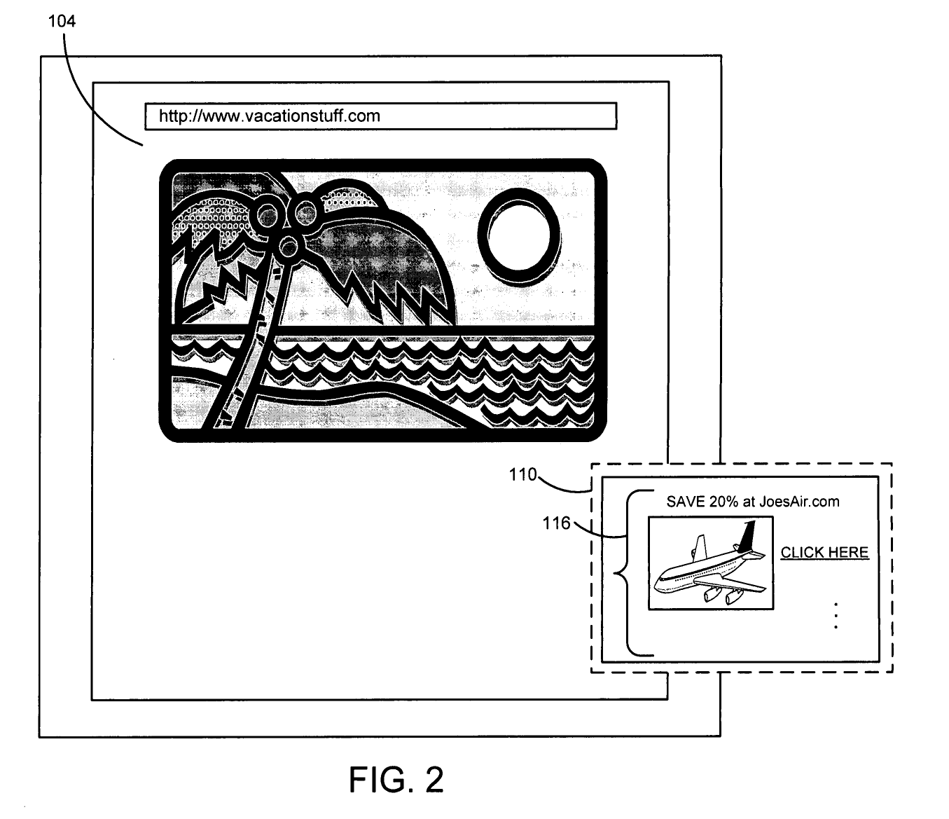

As shown in FIG. 2, a user operating the client 102 may navigate to an Internet or other network site, and thereby trigger or initiate a popup 110, for instance spawned from the parent window 104 presenting that site. The popup 110 so generated is illustrated in FIG. 2 in dotted outline, to indicate that actual display of the popup on client 102 may be suspended while analysis and decisioning activity according to the invention takes place. In general, the popup 110 may be or include an automatically generated new window instance, for example an HTML (hyper text markup language) page displayed in a new instance of a browser window. The popup 110 may likewise be generated in or from other applications or activities, or be expressed in other formats.

As shown, the initiated popup 110 may contain a set of content objects 116, which may include a variety of textual, graphical, video, audio, media, link and other information to be presented in a separate window or frame. For example, the set of content objects 116 may include graphical thumbnail, photograph or other images, for example in JPG (joint photographic experts group) or other formats. The set of content objects 116 may likewise include animated sequences, such as animated GIF files, sprites or other moving or dynamic objects. The set of content objects 116 may further contain audio, video or other media clips, samples or content such as MPG3 or WAV Windows™ format audio files, or Windows™ Media or Real™ format video clips. The media content embedded in popup 110 may for example be activated by mouse click, cursor hovering or other actions. The set of content objects 116 may further contain text or numeric characters or data, as well as code or data such as ActiveX™ or Java™ scripts or applets, HTML (hyper text markup language) links or other forms or data, including activatable or clickable Internet links or other addresses or references. Other types and classes of code, media or data may be included in the set of content objects 116 contained in, associated with or activated by the popup 110.

As further illustrated in FIG. 1, the initiation and display of popup 110 may in embodiments be managed by the popup manager 120 operating on client 102. In embodiments the popup manager 120 may detect the initiation of popup 110 by monitoring by the occurrence of an event in operating system 118 or associated graphical user interface, such as a Microsoft Windows™ “NewWindow2” event or other operating system or other events. A new popup event may include in one regard a request to spawn the popup 110 as a separate window or frame from parent window 104, for example when a hyperlink in parent window 104 is clicked or activated.

When the popup 110 is initiated and detected, the popup manager 120 may in embodiments apply a sequence of decisioning logic to determine whether to display that object to the user. The popup manager may in embodiments first apply initial decisioning criteria, to immediately include or exclude that popup for display. Popup manager 120 may for example apply initial decisioning criteria to look for indications that the popup 110 was directly caused by user-initiated actions, such as the clicking of a link embedded in a Web site, and may therefore be likely to be desired by the user.

In other embodiments, popup manager 120 may for instance measure the time between the last user action, such as typing a character or moving a mouse, and the initiation of the popup 110 to determine whether the popup 110 was generated by deliberate user action, as opposed to automatically triggered and therefore, less likely to be desired. According to embodiments in one regard, shorter times between those actions may conversely indicate a greater likelihood that user activity generated the popup event. When sufficient indicators that the user themselves initiated the popup 110 are present, the popup manager 120 may simply pass the popup to parent window 104 or other output, without further analysis because of confidence that the user initiated and desired the popup 110.

In the event that popup manager 120 can not determine that popup 110 was caused by user-initiated activity, the popup manager 120 may in embodiments apply further decisioning logic to permit or deny display. According to embodiments in one regard, the popup manager 120 may subsequently access a set of allow (whitelist) or disallow (blacklists) lists, for example to check the source URL (universal resource locator) or other associated identifiers of the popup 110 identifiers against those lists. If the associated URL or other identifier matches an allow or disallow list entry, the popup manager 120 may immediately deliver the popup 110 for display, or suppress the display of or terminate the popup 110, respectively.

Likewise, if the popup manager 120 can not match the URL or other associated identifier of the popup 110 to an allow or disallow list, the popup manager 120 may further apply a set of additional heuristics to the URL or other associated identifier or data related to the popup 110. For example, the popup manager 120 may assume that popup objects originating from a secure Web site, such as those having an “https:” format, are valid and desirable for display, whether the popup manager 120 is able to match the specific URL or domain to an allow/disallow list or not. The popup manager 120 may likewise store a list or table of domains which are known or confirmed to be valid, and a popup 110 originating from any specific address within that domain may be deemed desirable and be displayed. Other heuristic rules or criteria may be applied.

It may be noted that at this stage in processing, according to embodiments of the invention the actual internal content of popup 110 may not yet be delivered or transmitted to the popup manager 120 or other resources of client 102. For example, the popup 110 may not yet be accepted or received via TCP/IP (transfer control protocol/Internet protocol) port 80 or other Internet or other resources. That is, according to the invention in one regard the receipt of the set of content objects 116 by client 102 may be deferred while allow/disallow lookups, user-initiated activity checks or other non-content based processing is applied.

In embodiments, if the popup manager 120 can not exclude or include the popup 110 based on allow/disallow lists, domain identifiers or other non-content based criteria, in further processing the popup manager 120 may invoke or access a client-side filter 114 to generate a decision to display or not display the popup 110. At this processing stage, the set of content objects 116 may be downloaded or accessed from Internet or other sources. The client-side filter 114 may thus examine the set of content objects 116 of the popup 110 itself to generate that decision. According to embodiments of the invention in one regard, the client-side filter 114 may receive that content from popup manager 120 and decompose the various types of content in the set of content objects 116 to determine the type, quantity and other characteristics of those objects. For example, the client-side filter 114 may separate, categorize or otherwise identify attributes of the popup 110 and its content such as keywords, images, video clips, audio clips, embedded URLs or other links or other specific content or data.

When the set of content objects 116 is identified and categorized, the client-side filter 114 in embodiments may communicate with a weighting engine 122 to apply a set of weights, scaling factors or other functions or values to the content identified in the set of content objects 116. For example, the weighting engine 122 may apply a scaling weight of 0.40 to URLs which relate to established or legitimate financial providers or services, or vendors which the user has previously accessed by the user. Conversely, the weighting engine 122 may apply a weight for instance of 0.10 to a completely unknown URL. In embodiments, the special case of a popup 110 whose content is empty may be assumed to be undesirable, and for example given a weight of zero or otherwise rejected, canceled or suppressed.

Textual keywords which match lists or tables of known legitimate content or which are validly associated with the user, such as for example a known user name or address, may in cases be assigned comparatively greater weights. Weights may for example be fixed in value, or in embodiments may expressed or applied as a sliding scale or other variable function. Other weightings, scalings or normalizations may be applied to the various objects, code or data constituting the set of content objects 116 to quantify their contribution to the desirability of displaying a given popup 110.

According to the invention in another regard, after the weighting engine has attached or processed weights to the set of content objects 116, the client-side filter 114 may in instances add those weights to reach a composite score. In embodiments, the client-side filter 114 may, for instance, calculate an average the total of all weighted factors over the number of objects in the set of content objects. Other computations, for example calculations by which a sliding scale of weights are applied to different parts of the set of content objects 116, designed to generate an aggregate figure of merit are possible. For example, weights on individual components may be increased as a greater number of positive indicators are detected. Other functions are possible.

According to embodiments of the invention in one regard, after a composite or integrated value or values are calculated, the client-side filter 114 may compare that value to a display threshold 124 for display decisioning. The display threshold 124 may represent a minimum score of estimated desirability which a popup 110 must reach before being permitted to be displayed to the user. For example, the display threshold 124 may be set to a value of 0.80, representing in embodiments for instance an 80% degree of confidence that the popup 110 is desired by the user and should be displayed. Other values, variable values or functions may be used in or for display threshold 124. In embodiments the display threshold 124 itself may be fixed, or in embodiments may be assigned on a sliding scale. Other schemes are possible.

In embodiments, the weights applied by the weighting engine 122, the display threshold 124 and other decision logic employed by client-side filter 114, popup manager 122 and related resources may each be installed on or seeded to client 102 by way of Internet or other network downloads, or loaded from CD-ROM or other media. That code and data may for example be installed as part of media, communications or other applications, or may be loaded from other sources. In embodiments of the invention in another regard, the initial or default values of weights, heuristics, display thresholds and other data or logic may be generated from the cumulative experiences or feedback of prior users, or be derived from other sources. For example an Internet service provider may maintain a database of popup management data for its users, from which default or baseline allow/disallow URLs, display thresholds and other information may be empirically derived.

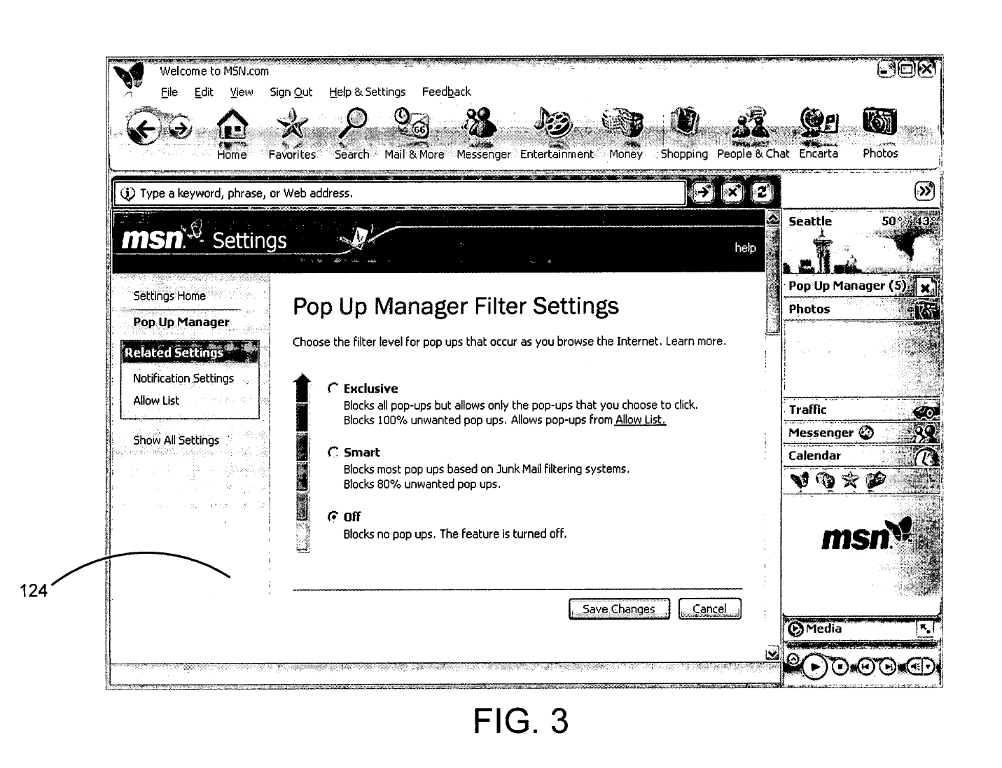

As shown in FIG. 3, according to embodiments of the invention in another regard, in operation the user may be presented with a control interface 124 operated on client 102, to selectively adjust the strength of the filtering action applied by the invention. This may be accomplished for example by adjusting the sensitivity, weights or thresholds applied by the weighting engine 122 of client-side filter 114, such as display threshold 124, or otherwise. As illustratively shown, a user may in one regard be presented with options including, for example, a set of choices to select exclusive popup blocking (none allowed except from whitelist), smart filtering where content ratings are generated, or no filtering. Other options may be presented, including for example to permit a user to select a degree of confidence necessary to permit a popup 110 to be displayed when “smart” or content-based filtering is applied. For example, confidence measures of 75% or 90% may be selected before allowing popup 110 to be displayed, or qualitative categories such as “strong” or “moderate” selections may be presented. Other variables or preferences may be controlled via control interface 124, or other interfaces or dialogues.

According to the invention in further regard, and as likewise illustrated in FIG. 1, in embodiments after the popup manager 120 has analyzed the popup 110 for both content and non-content based criteria and found no factors to exclude that object from display, or when for instance the popup 110 generates a marginal rating score, the popup manager 120 may communicate information regarding the popup 110 to a content filter engine 112 for additional analysis or decisioning. The content filter engine 112 may in embodiments for example executed or be hosted on a remote server 106, or elsewhere. The content filter engine 112 may in one regard examine data such as the specific URL or other address or identifier associated with the popup 110, and compare that URL or other identifier against a filter database 108.

The filter database 108 may for example store lists of URL or other address, identifier or source information along with an indication whether popup content from each of those sites or sources should be displayed or blocked, in the absence of other decisioning on that content. Filter database 108 may in one regard be built from popup decisioning histories or results of other users over time, including user feedback results if any. Thus for example if the popup 110 is encountered by the user for the first time and passes all non-content and content-based analyses performed by popup manager 120 and/or client-side filter 114, the popup 110 may be additionally checked against the filter database 108 by content filter engine 112.

If the content filter engine 112 determines that the popup 110 should be blocked based on filter database 108, the content filter engine 112 may transmit a message to client 102 to block popup 110 based on that check. Conversely content filter engine 112 may confirm the acceptance of popup 110 for display, for example if URLs or other addresses or identifiers match a positive display list in filter database 108. Because accessing the content filter engine 112 and associated filter database 108 may in one regard be comparatively costly in terms of bandwidth used, response time from server 106 or other performance variables, this check may in embodiments be reserved for the last step or stage in the sequence of popup display analysis. In other embodiments, the step of accessing a remote content filter engine 112 may be omitted, and the decision to display or not display the popup 110 may be processed solely by resources of client 102. Other configurations or sequences are possible.

According to embodiments of the invention in another regard, when the popup manager 120 has generated a decision to display or not display the popup 110, the user may be queried via a dialog box or otherwise about the display decision for popup 110. For example if the popup 110 has passed all processing stages but not yet been displayed, the user may be prompted with a notification that popup 110 is pending for display. The user may then override that decision to then cancel or suppress the display of popup 110, if desired. In other embodiments, the user may be queried for their agreement or disagreement with the decision about displaying popup 110 after the popup has been displayed, for example by live site feedback for system learning or feedback purposes.

In embodiments of those types, instances of user overrides or other feedback may for instance be inputted to client-side filter 114, to content filter engine 112 or other resources to seed or improve weighting or other activity. This type of user feedback may be used to improve the accuracy with which popups may be blocked for a given user, group of users or all participating users if desired. For instance, the client-side filter 114, content filter engine 112 or other resources may each contain or access a self-learning network such as a neural network or support vector machine which accepts live or other user feedback and other inputs, to improve decision logic. Other decision mechanisms or infrastructures are possible.

According to further embodiments of the invention in another regard, the popup manager 120 may in cases display a representation or notification of the popup 110 at various stages of processing, instead of the full popup 110 itself. For example, a thumbnail representation or ghosted version of popup 110, or the URL associated with the popup 110, may be presented rather than the popup 110 itself. In embodiments, a thumbnail or other substitute representation may be presented even if the popup 110 is determined to be desirable for display, for instance to permit the user the option to select or highlight the popup 110 via its thumbnail or other representation, or to cancel the popup 110 without fully opening the object. In other embodiments a thumbnail or other representation may be presented, for example in reduced size, while decision processing is taking place. Other display configurations are possible.

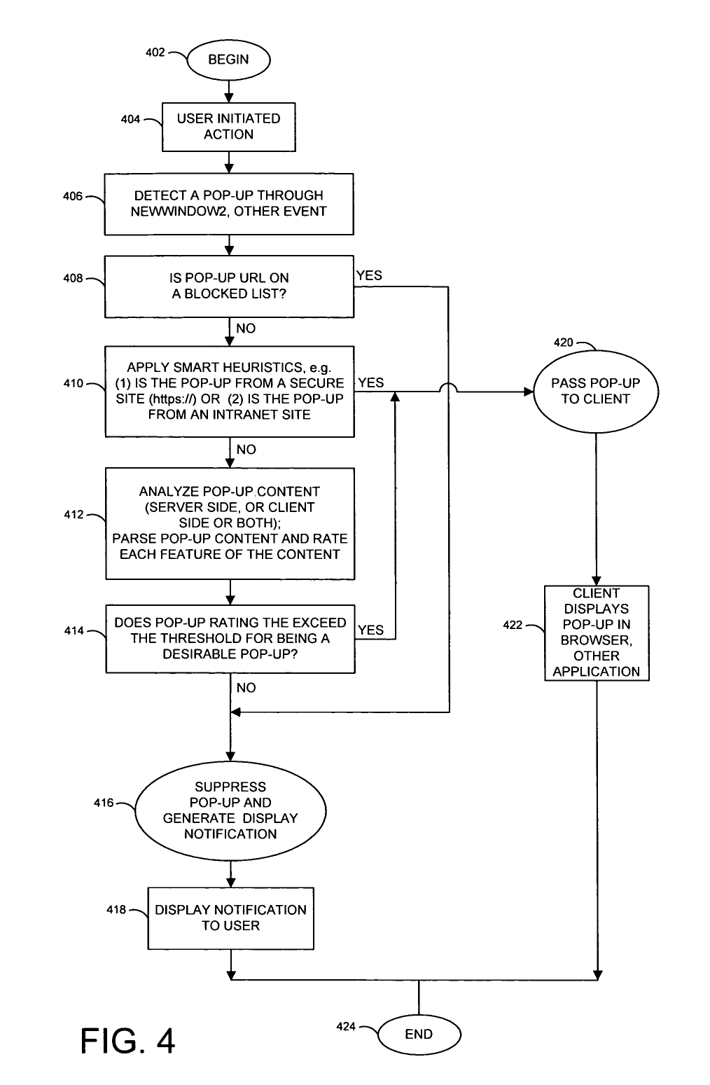

Overall popup management processing according to embodiments of the invention is illustrated in FIG. 4. In step 402, processing may begin. In step 404, a user-initiated action, such as a mouse click, URL highlight, cursor hover or other action or input may take place or be detected. In step 406, the initiation of a popup 110 may be detected, for instance via detection of a Windows™ NewWindow2 or other event, which may be detected or reported for instance via operating system 118 or otherwise. In step 408, a determination may be made whether a URL or other associated identifier of popup 110 is present on a block or disallow list (blacklist). If the URL or other identifier of popup 110 is not on an applicable disallow list, processing may proceed to step 410 where heuristic processing may be applied. For example, a determination may be made whether the popup 110 originated from a secure site (e.g. https:// site), from an intranet site or other trusted sources, or other heuristics may be applied. If a determination is made in step 410 that the conditions or criteria of the set of heuristics are not satisfied, processing may proceed to step 412.

In step 412, the set of content objects 116 of popup 110 may be analyzed, for example in client-side filter 114, in content filter engine 112 or both. For instance, the set of content objects 116 or other features may be parsed and individually rated for an indication of desirability, for example via weighting engine 122. In step 414, the aggregate or cumulative rating of the popup 110 as a whole, for instance the sum, average or other metric or function applied to ratings on the set of content objects 116, may be compared to display threshold 124 or other decision threshold or function.

In step 416, if a determination is made that the rating on the content of popup 110 does not satisfy display threshold 124, the display of popup 110 on client 102 may be suppressed or cancelled, and a notification of that suppression may be generated. In step 418 that notification may be displayed to the user, for instance via a temporary text display, cursor or toolbar flash or other indicator. In step 424, processing may repeat, return to a prior processing point, proceed to a further processing point or end.

In step 410, if a determination is made that heuristics such as those involving or testing for secure URL or other indicators or criteria are satisfied, processing may proceed to step 420 where the popup 110 may be passed or transmitted to client 102, including the set of content objects 116. In step 422, the popup 110 may consequently be displayed on client 102, for instance in a browser or other application. Control may then proceed to step 424, where processing may repeat, return to a prior processing point, proceed to a further processing point or end.

The foregoing description of the invention is illustrative, and modifications in configuration and implementation will occur to persons skilled in the art. For instance, while the invention has generally been described in terms of intelligent filtering action being applied to a single popup object presenting in a single parent window, in embodiments the filtering logic may analyze two or more popups together or concurrently, or a string of self-opening popups spawned by other popups. For further example, while the invention has been generally described in terms of a user operating a personal computer as client 102, in embodiments the client 102 or other viewing device may be or include other networked or communications devices, such as a data-enabled cellular telephone, a networked digital assistant, or other clients or machines.

Similarly, while the invention has in embodiments been described as accessing a single filter database 108 to retrieve stores of URLs or other data, in embodiments two or more local or distributed databases or data stores may be used to host the same or similar data. Further, while the invention has generally been described in terms of embodiments in which certain decision intelligence is hosted in or applied by client-side filter 114, in embodiments some or all of that intelligence may be hosted by remote resources such as content filter engine 112, another remote server, or other local or remote resources. Other hardware, software or other resources described as singular may in embodiments be distributed, and similarly in embodiments resources described as distributed may be combined. Again, while the invention has generally been illustrated in terms of capturing popup events launched from a browser window, in embodiments the filter system may detect and capture popups or other objects from other applications or processes, such as media players or others.

Yet further, while the initiated objects have generally been described as consisting of popups, which may include the characteristic of being spawned from parent window 104, in embodiments popunders (displayed under a parent window 104 and not visible until that window is minimized, moved or closed), animations and other objects may likewise be controlled. The scope of the invention is accordingly intended to be limited only by the following claims.

We claim:

1. A system for managing the display of popups, comprising:
an interface to receive a popup object spawned in a parent window; and
a filter engine, the filter engine communicating with the interface to receive the popup object and generate a display decision based on analysis of the content of the popup object.

2. A system according to claim 1, wherein the interface comprises a popup host.

3. A system according to claim 1, wherein the parent window comprises a browser.

4. A system according to claim 1, wherein the filter engine comprises a client-side filter.

5. A system according to claim 1, wherein the filter engine comprises a server-side filter engine.

6. A system according to claim 1, wherein the content of the popup object analyzed comprises at least one of the presence of a graphical image, the presence of a video object, the presence of an animation object, the presence of an audio sample, the presence of at least one keyword, the presence of user-supplied input, the source of the popup object, the absence of content in the popup object and a destination of a link in the popup object.

7. A system according to claim 1, wherein the filter engine comprises a self-learning network.

8. A system according to claim 1, further comprising an interface to a filter database, the filter database storing a set of decisioning criteria for at least one user.

9. A system according to claim 8, wherein the filter database comprises a local database.

10. A system according to claim 8, wherein the filter database comprises a remote database.

11. A system according to claim 8, wherein the decisioning criteria comprise at least a display threshold.

12. A system according to claim 11, wherein the display threshold comprises a composite rating for a set of content objects present in the popup object.

13. A system according to claim 1, wherein the filter engine comprises a dialog interface to query a user for popup display preferences.

14. A method for managing the display of popups, comprising:
receiving a popup object spawned in a parent window; and
generating a decision to display the popup object based on an analysis of the content of the popup object.

15. A method according to claim 14, wherein the receiving is performed in a popup host.

16. A method according to claim 14, wherein the parent window comprises a browser.

17. A method according to claim 14, wherein generating a decision is performed via a client-side filter.

18. A method according to claim 14, wherein generating a decision is performed via a server-side filter engine.

19. A method according to claim 14, wherein the analysis comprises analyzing at least one of the presence of a graphical image, the presence of a video object, the presence of an animation object, the presence of an audio sample, the presence of at least one keyword, the presence of user-supplied input, the source of the popup object, the absence of content in the popup object and a destination of a link in the popup object.

20. A method according to claim 14, wherein generating a decision is performed via a self-learning network.

21. A method according to claim 14, further comprising storing a set of decisioning criteria for at least one user in a filter database.

22. A method according to claim 21, wherein the decisioning criteria comprise at least a display threshold.

23. A method according to claim 22, wherein the display threshold comprises a composite rating for a set of content objects present in the popup object.

24. A popup object, the popup object being managed according to a method comprising:
receiving a popup object spawned by a parent window; and
generating a decision to display the popup object based on an analysis of the content of the popup object.

25. A popup object according to claim 24, wherein the parent window comprises a browser.

26. A popup object according to claim 24, wherein generating a decision is performed via a client-side filter.

27. A popup object according to claim 24, wherein generating a decision is performed via a server-side filter engine.

28. A popup object according to claim 24, wherein the analysis comprises analyzing at least one of the presence of a graphical image, the presence of a video object, the presence of an animation object, the presence of an audio sample, the presence of at least one keyword, the presence of user-supplied input, the source of the popup object, the absence of content in the popup object and a destination of a link in the popup object.

29. A popup object according to claim 24, wherein generating a decision is performed via a self-learning network.

30. A popup object according to claim 24, wherein the method further comprises storing a set of decisioning criteria for at least one user in a filter database.

31. A popup object according to claim 30, wherein the decisioning criteria comprise at least a display threshold.

32. A popup object according to claim 31, wherein the display threshold comprises a composite rating for a set of content objects present in the popup object.

33. A system for managing the display of popups, comprising:
interface means to receive a popup object spawned by a parent window; and
filter means, the filter means communicating with the interface means to receive the popup object and generate a display decision based on analysis of the content of the popup object.

34. A system according to claim 33, wherein the content of the popup object analyzed comprises at least one of the presence of a graphical image, the presence of a video object, the presence of an animation object, the presence of an audio sample, the presence of at least one keyword, the presence of user-supplied input, the source of the popup object, the absence of content in the popup object and a destination of a link in the popup object.
